(19) United States
(12) Patent Application Publication
(10) Pub. No.: US 2025/0330842 A1
(43) Pub. Date: Oct. 23, 2025

(54) COMMUNICATIONS NETWORK RESILIENCY TO ENVIRONMENTAL THREATS

(71) Applicant: AT&T Intellectual Property I, L.P., Atlanta, GA (US)

(72) Inventor: Irwin Gerszberg, Kendall Park, NJ (US)

(21) Appl. No.: 18/641,194

(22) Filed: Apr. 19, 2024

(51) Int. Cl. H04W 24/04; H04W 40/12; H04W 76/19

(52) U.S. Cl. CPC H04W 24/04; H04W 40/12; H04W 76/19

(57) ABSTRACT

A method performed by a processing system including at least one processor includes querying a remote device for recovery data for a network element of a communications network, where the recovery data includes at least: an interval of time to wait before attempting a reconnection to the communications network following a failure of the communications network and a maximum number of times to attempt the reconnection following the failure, receiving the recovery data from the remote device, storing the recovery data in a memory of the network element, detecting a first failure of the communications network, activating, in response to the detecting, a timer of the network element, where the timer is configured to count down an amount of time that is equal in duration to a duration of the interval of time, and attempting, in response to the timer expiring, the reconnection to the communications network.

The present disclosure relates generally to communications networks and relates more particularly to devices, non-transitory computer-readable media, and methods for improving communications network resiliency to environmental threats such as electromagnetic pulses, solar flares, coronal mass ejections, and the like.

### SUMMARY

In one example, the present disclosure describes a device, computer-readable medium, and method for improving communications network resiliency to environmental threats such as electromagnetic pulses, solar flares, coronal mass ejections, and the like. For instance, in one example, a method performed by a processing system including at least one processor includes querying a remote device for recovery data for a network element of a communications network, where the recovery data includes at least: an interval of time to wait before attempting a reconnection to the communications network following a failure of the wireless network and a maximum number of times to attempt the reconnection following the failure, receiving the recovery data from the remote device, storing the recovery data in a memory of the network element, detecting a first failure of the communications network, activating, in response to the detecting, a timer of the network element, where the timer is configured to count down an amount of time that is equal in duration to a duration of the interval of time, and attempting, in response to the timer expiring, the reconnection to the communications network.

In another example, a non-transitory computer-readable medium stores instructions which, when executed by a processor, cause the processor to perform operations. The operations include querying a remote device for recovery data for a network element of a communications network, where the recovery data includes at least: an interval of time to wait before attempting a reconnection to the communications network following a failure of the communications network and a maximum number of times to attempt the reconnection following the failure, receiving the recovery data from the remote device, storing the recovery data in a memory of the network element, detecting a first failure of the communications network, activating, in response to the detecting, a timer of the network element, where the timer is configured to count down an amount of time that is equal in duration to a duration of the interval of time, and attempting, in response to the timer expiring, the reconnection to the communications network.

In another example, a device includes a processor and a computer-readable medium storing instructions which, when executed by the processor, cause the processor to perform operations. The operations include querying a remote device for recovery data for a network element of a communications network, where the recovery data includes at least: an interval of time to wait before attempting a reconnection to the communications network following a failure of the communications network and a maximum number of times to attempt the reconnection following the failure, receiving the recovery data from the remote device, storing the recovery data in a memory of the network element, detecting a first failure of the communications network, activating, in response to the detecting, a timer of the network element, where the timer is configured to count down an amount of time that is equal in duration to a duration of the interval of time, and attempting, in response to the timer expiring, the reconnection to the communications network.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a flowchart of an example method for improving communications network resiliency to environmental threats, in accordance with the present disclosure;

FIG. 3 illustrates a flowchart of an example method for improving communications network resiliency to environmental threats, in accordance with the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure improves communications network resiliency to environmental threats such as electromagnetic pulses, solar flares, coronal mass ejections, and the like. Much of the technology that society has come to rely on, including the electrical grid, communications networks (including wired and wireless telecommunications networks), and the like, are susceptible to damage and disruption from environmental threats such as electromagnetic pulses (EMPs, i.e., short bursts of electromagnetic energy), solar flares (i.e., intense, localized emissions of electromagnetic radiation originating in the sun's atmosphere), and coronal mass ejections (CMEs, i.e., ejections of magnetic fields and accompanying plasma mass from the sun's corona).

The United States government has defined a standard which requires structures that house non-civilian communications and other electronic equipment to be hardened to at least eighty decibels (dB). This degree of isolation protects the housed equipment from damage and disruption caused by environmental threats such as those discussed above. However, achieving this degree of isolation is expensive and time consuming, and therefore infeasible for most civilian applications including commercial communications networks.

Examples of the present disclosure provide communications networks with a level of resiliency to environmental threats that is sufficient to prevent prolonged disruption, but at a fraction of the cost of measures employed for non-civilian applications. In one example, a pre-existing structure, such as an existing office building or other structures, may be hardened using available materials such as Faraday fabrics, nanoparticle paint, or the like. Since most modern buildings are already hardened to approximately twenty-five dB, this further hardening may provide as much as forty dB of total hardening to the pre-existing structure. In most cases, forty dB is sufficient to prevent lasting physical damage to any network equipment housed within the pre-existing structure.

Further examples of the present disclosure provide a routine for automatically reestablishing connections between the network and the network elements of the network after exposure to an environmental threat. In one example, a repository may store, for each network element, a respective timer that defines an interval of time that each network element is to wait before attempting a reconnection to the network after a network-wide crash (i.e., an event in which multiple, or in some cases, all network elements fail at approximately the same time). The repository may also store, for each network element, a respective number of times that the network element is to attempt the reconnection (in the event that a first attempt to reconnect is unsuccessful). The interval of time and the number of times to attempt the reconnection may differ for each network element, so that the network elements come back online in a staggered manner, avoiding race conditions (e.g., conditions in which multiple network elements may all be trying to reconnect to the network at the same time, regardless of dependencies). For instance, a first network element may be incapable of reconnecting to the network until a second network element is reconnected. In this case, the interval of time associated with the first network element may be longer than the interval of time associated with the second network element, in order to give the second network element an opportunity to reconnect to the network before the first network element attempts to reconnect (which increases the probability of the first network element successfully reconnecting).

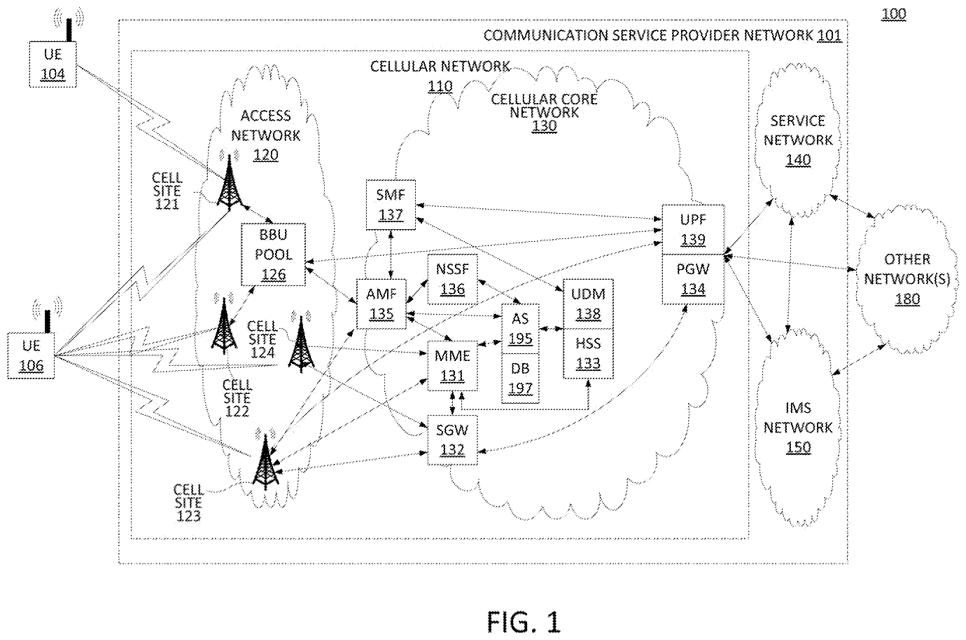

Although examples of the disclosure are discussed within the context of providing resiliency to environmental threats, it will be appreciated that aspects of the disclosure may provide a measure of resiliency to other, non-environmental network threats (e.g., network intrusions, non-environmental related power failures, or the like). Moreover, although examples of the present disclosure are discussed within the context of providing resiliency for wireless telecommunications networks, it will be appreciated that the same measures described herein can be applied to improve the resiliency of any type of communications network, including wired communications networks, content distribution networks, cable television networks, fiber optic networks, and the like. These and other aspects of the present disclosure are discussed in greater detail in connection with FIGS. 1-4, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a radio access network (RAN), such as a cloud RAN, a distributed RAN (D-RAN), a centralized RAN (C-RAN), a virtualized RAN (V-RAN), or an open RAN (O-RAN). For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

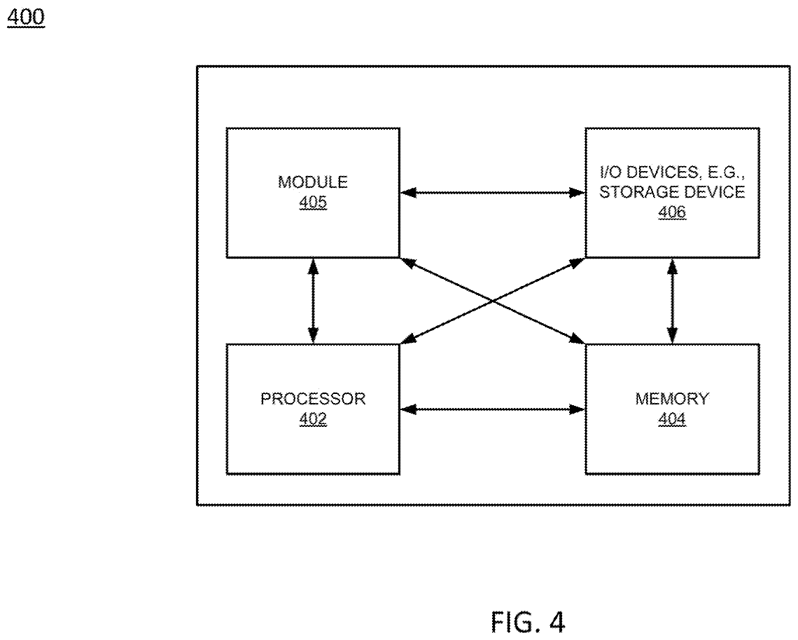

In accordance with the present disclosure, any one or more of cell sites 121-123 may be deployed with antenna and radio infrastructures, including MIMO and millimeter wave antennas. Furthermore, in accordance with the present disclosure, a base station (e.g., cell sites 121-123 and/or baseband units within BBU pool 126) may comprise all or a portion of a computing system, such as computing system 400 as depicted in FIG. 4, and may be configured to perform steps, functions, and/or operations in connection with examples of the present disclosure for improving communications network resiliency to environmental threats.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QOS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and/or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. Each of the UEs 104 and 106 may comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). For instance, each of the UEs 104 and 106 may include one or more radio frequency (RF) transceivers for cellular communications and/or for non-cellular wireless communications. In one example, each of the UEs 104 and 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

In one example, each of the UEs 104 and 106 may comprise all or a portion of a computing system, such as computing system 400 depicted in FIG. 4, and may be configured to perform steps, functions, and/or operations in connection with examples of the present disclosure for improving wireless network resiliency to environmental threats. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, the cellular core network 130 may further include an application server (AS) 195, which may comprise a computing system or server, such as computing system 400 depicted in FIG. 4, and may be configured to provide one or more operations or functions in connection with examples of the present disclosure for improving communications network resiliency to environmental threats. The cellular core network 130 may also include a database (DB) 197 that is communicatively coupled to the AS 195.

The AS 195 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, the AS 195 may be configured to improve the resiliency of the communication service provider network 101 to environmental threats such as electromagnetic pulses, solar flares, coronal mass ejections, and the like. For instance, in some examples, the AS 195 may control management and distribution of recovery data for various network elements of the communication service provider network 101 (including, e.g., any of the network elements 121, 122, 123, 124, 126, 131, 132, 133, 134, 135, 136, 137, 138, or 139 as described above), where the recovery data can be used to control the manner in which the network elements reconnect to the communication service provider network 101 after a network-wide failure. In one example, the recovery data may include, for each network element, at least: an interval of time to wait before attempting a reconnection to the communications network following a failure of the communications network and a maximum number of times to attempt the reconnection following the failure. In one example, the recovery data may be defined by a human technician and provided to the AS 195.

In this example, the DB 197 may operate as a repository for the recovery data. For instance, the AS 195 may store the recovery data in the DB 197. When a network element queries the AS 195 for the network element's respective recovery data, the AS 195 may retrieve the network element's respective recovery data from the DB 197 and deliver the network element's respective recovery data to the network element.

Moreover, as the topology of the communication service provider network 101 changes, the AS 195 may update the recovery data that is stored in the DB 197. For instance, when network elements are added to or removed from the communication service provider network 101, when existing network elements are moved within the communication service provider network 101, when new connections between network elements are established or existing connections between network elements are removed, such changes may necessitate a change in the manner (e.g., order, timing, or the like) in which the network elements of the communication service provider network 101 reconnect to the communication service provider network 101.

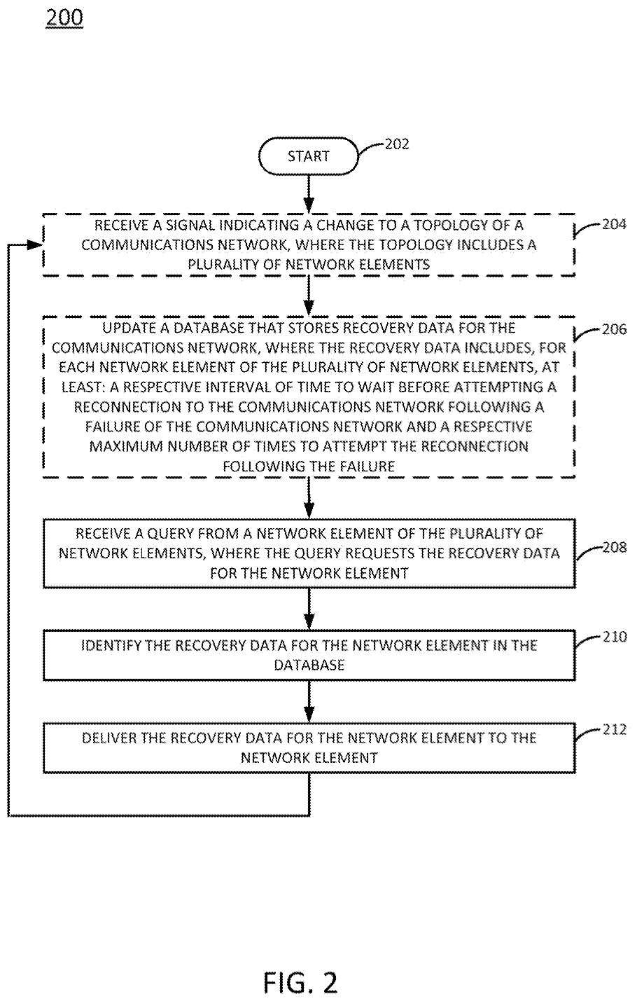

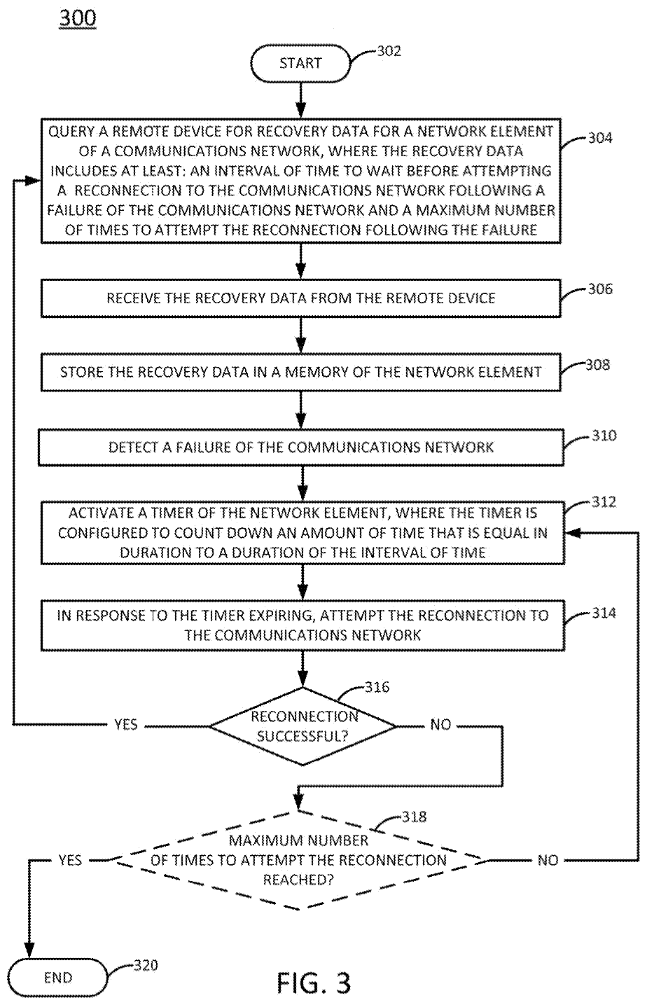

In one example, the DB 197 may comprise a physical storage device integrated with the AS 195 (e.g., a database server or a file server), or attached or coupled to the AS 195, in accordance with the present disclosure. In one example, the AS 195 may load instructions into a memory, or one or more distributed memory units, and execute the instructions for improving communications network resiliency to environmental threats, as described herein. Example methods for improving communications network resiliency to environmental threats are described in greater detail below in connection with FIG. 2 and FIG. 3.

In one example, the cellular core network 130 may include multiple instances of the AS 195 and DB 197 distributed throughout the cellular core network 130, where the multiple instances each store identical data for the purposes of redundancy.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of the cell sites 121-123 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

To further aid in understanding the present disclosure, FIG. 2 illustrates a flowchart of an example method 200 for improving communications network resiliency to environmental threats, in accordance with the present disclosure. In one example, the method 200 may be performed by an application server that is configured to manage recovery data for the network elements of a communications network, such as the AS 195 illustrated in FIG. 1. However, in other examples, the method 200 may be performed by another device, such as the processor 402 of the system 400 illustrated in FIG. 4. For the sake of example, the method 200 is described as being performed by a processing system.

The method 200 begins in step 202. In optional step 204 (illustrated in phantom), the processing system may receive a signal indicating a change to a topology of a communications network, where the topology includes a plurality of network elements.

In one example, the communications network may comprise a wireless telecommunications network, and the plurality of network elements may include at least one of: a radio unit on a cellular base station, a baseband unit at a cell site, a smart integrated access device at a cell site, a global positioning system at a cell site, a network timing alarm at a cell site, a door alarm at a cell site, a heating, ventilation, and air conditioning alarm at a cell site, network terminating equipment for Ethernet transport infrastructure at a cell site, an optical fiber regeneration site, optical add/drop infrastructure, optical monitoring infrastructure, optical cable locate infrastructure, Ethernet network infrastructure at a central office, a mobile telephone switching office (in one example, mobile telephone switching office multiple subscriber numbering should have primary and secondary routing to multiple mobile telephone switching offices in different locations), a mobility packet core location (in one example, mobility packet core location multiple subscriber numbering should have primary and secondary routing to multiple mobility packet core locations in different locations), a switching center (in one example, a switching center should have multiple routing to different locations), a data center (in one example, a data center should have multiple routing to different locations), a central office location, a gigabit passive optical network (or other active Ethernet infrastructures), an optical network terminal, a whitebox network element, an edge routing facility (including equipment), a core routing facility (including equipment), any of the network elements 121, 122, 123, 124, 126, 131, 132, 133, 134, 135, 136, 137, 138, or 139 illustrated in FIG. 1, or other network elements.

In another example, the communications network may comprise a cable television operator network (e.g., a fiber optic television network), and the plurality of network elements may include at least one of: an optical fiber regeneration site, optical add/drop infrastructure, optical monitoring infrastructure, optical cable locate infrastructure, Ethernet network infrastructure, a gigabit passive optical network (or other active Ethernet infrastructure), a switching center (in one example, a switching center should have multiple routing to different locations), a data center (in one example, a data center should have multiple routing to different locations), an optical network terminal, a whitebox network element, an edge routing facility (including equipment), a core routing facility (including equipment), a hybrid fiber-coaxial terminal, a line amplifier, or other network elements.

Whatever the nature of the communications network, in one example, at least some network elements of the plurality of network elements may be housed in structures whose hardening has been augmented using nanoparticle paints, Faraday fabrics, or other materials that can be used to increase the hardening of a structure. In one example, the augmentation may result in a total hardening of approximately forty to fifty dB for the structure (where the hardening of the structure, pre-augmentation, may have been approximately twenty to thirty dB). In one example, the plurality of network elements may be distributed across a plurality of structures whose hardening has been augmented in this manner.

Step 204 is considered optional because the topology of the communications network may change at any time. For instance, network elements may be added to or removed from the communications network at any time, existing network elements in the communications network may be moved or deactivated, or connections between existing network elements may be added or removed. When such a change occurs, the processing system may be notified of the change in the topology or may detect the change in the topology without being explicitly notified.

In optional step 206 (illustrated in phantom), the processing system may update a database that stores recovery data for the communications network, where the recovery data includes, for each network element of the plurality of network elements, at least: a respective interval of time to wait before attempting a reconnection to the communications network following a failure of the communications network and a respective maximum number of times to attempt the reconnection following the failure.

In one example, updating the database may include updating the recovery data for at least one network element that was affected by the change to the topology of the communications network. For instance, updating the database may include creating a new entry for a newly added network element and adding recovery data for the newly added network element to the database. Updating the database could also include removing an entry for a network element that was removed or deactivated. Updating the database could also include changing the recovery data for an existing network element that is now connected to a newly added network element, that is newly connected to another existing network element, or that was connected to a network element that was removed or deactivated.

In the event of a network-wide failure, the plurality of network elements may lose power and/or connectivity to the communications network. If power has been lost, then the plurality of network elements may need to power up and reboot. Once rebooted, the plurality of network elements will need to reestablish their connections to the communications network. However, race conditions may result if all network elements of the plurality of network elements attempt to reestablish their connections simultaneously. As such, the recovery data for each network element will define a respective interval of time. This respective interval of time defines, for a given network element, an amount of time (e.g., in seconds, minutes, or the like) after the network-wide failure or reboot of the given network element to wait before attempting a reconnection to the communications network. The duration of the respective interval of time may be different for different network elements (e.g., shorter for some, longer for others), so that the plurality of network elements come back online in a staggered or gradual manner. For instance, if a first network element cannot reconnect to the communications network until a second network element has reconnected to the communications network, then the duration of the interval of time for the first network element may be shorter than the duration of the interval of time for the second network element (in order to allow the second network element an opportunity to reconnect before attempting reconnection of the first network element).

The recovery data for each network element will also define a respective maximum number of times to attempt the reconnection. For instance, an attempt to reconnect to the communications network may fail for any one or more of a number of reasons, including the possibility that other network elements may not yet be reconnected. Thus, the recovery data may allow for a network element to reattempt reconnecting to the communications network in the event that a previous attempt is unsuccessful. However, the number of reattempts may be capped at a maximum number to avoid overwhelming the network or inadvertently masking of other problems with the network element. Like the duration of the interval of time, the maximum number of times to attempt the reconnection may be different for different network elements.

In a further example, the recovery data may include additional parameters related to the reboot and network reconnection of a network element. For instance, the recovery data may further include data related to alternate routing or dependencies for a network element. As discussed above, some network elements, such as a mobile telephone switching office, a mobility packet core location, a switching center, or a data center may have primary and secondary routing to multiple alternate network elements in different locations. Thus, the recovery data may identify, for such network elements, the alternate network elements. As also discussed above, some network elements may be unable to reconnect to the communications network before other network elements first reconnect. In this case, the recovery data may identify, for a given network element, any network elements that must reconnect before the given network element can reconnect and/or any network elements that cannot reconnect until the given network element reconnects.

In step 208, the processing system may receive a query from a network element of the plurality of network elements, where the query requests the recovery data for the network element. For instance, any of the network elements for which the database stores recovery data may query the processing system, via the communications network, for that recovery data. In one example, each network element of the plurality of network elements may periodically query the processing system for its recovery data while the network element is connected to the communications network. As discussed in further detail below, each network element may store its recovery data locally, and each time the network element queries the processing system for the recovery data, the network element may overwrite its previously stored recovery data with recovery data that is provided in response to the query.

In step 210, the processing system may identify the recovery data for the network element in the database. For instance, in one example, the processing system may query the database or perform a lookup in the database using identifying information for the network element. The query received from the network element may include identifying information for the network element, such as IP address, media access control address, nickname, manufacturer, make and model number, or the like. This identifying information may be used as an index into a lookup table which maps the identifying information to recovery data for the network element.

In step 212, the processing system may deliver the recovery data for the network element to the network element. For instance, the processing system may send an electronic signal, via the communications network, to the network element, where the electronic signal encodes the recovery data and can be decoded by the network element to retrieve the recovery data.

The method 200 may then return to either step 204 (if a new signal indicating a change to the topology of the communications network is received) or step 206 (if a new query is received from another network element of the plurality of network elements), and may proceed as described above.

For instance, as discussed above, the network element, as well as other network elements of the communications network, may periodically query the processing system for updated recovery data. The processing system may update the recovery data for the plurality of network elements as the processing system receives changes in recovery data and communications network topology. In this way, each network element is expected to always be in possession of the most recent recovery data for the network element. This will allow the network elements to reestablish connections to the communications network after a network-wide failure without requiring network connectivity to retrieve the recovery data. Thus, the processing system may continuously iterate through steps 204-212 and/or 206-212 for as long as the communications network is functioning.

FIG. 3 illustrates a flowchart of an example method 300 for improving communications network resiliency to environmental threats, in accordance with the present disclosure. In one example, the method 300 may be performed by a network element of a communications network, such as any of the network elements 121, 122, 123, 124, 126, 131, 132, 133, 134, 135, 136, 137, 138, or 139 illustrated in FIG. 1. However, in other examples, the method 300 may be performed by another device, such as the processor 402 of the system 400 illustrated in FIG. 4. For the sake of example, the method 300 is described as being performed by a processing system.

The method 300 begins in step 302. In step 304, the processing system may query a remote device for recovery data for a network element of a communications network, where the recovery data includes at least: an interval of time to wait before attempting a reconnection to the communications network following a failure of the communications network and a maximum number of times to attempt the reconnection following the failure.

In one example, the processing system may be part of the network element, and the network element may be one of a plurality of network elements of the communications network. In one example, the communications network may comprise a wireless telecommunications network, and the network element may be one of: a radio unit on a cellular base station, a baseband unit at a cell site, a smart integrated access device at a cell site, a global positioning system at a cell site, a network timing alarm at a cell site, a door alarm at a cell site, a heating, ventilation, and air conditioning alarm at a cell site, network terminating equipment for Ethernet transport infrastructure at a cell site, an optical fiber regeneration site, optical add/drop infrastructure, optical monitoring infrastructure, optical cable locate infrastructure, Ethernet network infrastructure at a central office, a mobile telephone switching office (in one example, mobile telephone switching office multiple subscriber numbering should have primary and secondary routing to multiple mobile telephone switching offices in different locations), a mobility packet core location (in one example, mobility packet core location multiple subscriber numbering should have primary and secondary routing to multiple mobility packet core locations in different locations), a switching center (in one example, a switching center should have multiple routing to different locations), a data center (in one example, a data center should have multiple routing to different locations), a central office location, a gigabit passive optical network (or other active Ethernet infrastructure), an optical network terminal, a whitebox network element, an edge routing facility (including equipment), a core routing facility (including equipment), any of the network elements 121, 122, 123, 124, 126, 131, 132, 133, 134, 135, 136, 137, 138, or 139 illustrated in FIG. 1, or other network elements.

In another example, the communications network may comprise a cable television operator network (e.g., a fiber optic television network), and the network element may be one of: an optical fiber regeneration site, optical add/drop infrastructure, optical monitoring infrastructure, optical cable locate infrastructure, Ethernet network infrastructure, a gigabit passive optical network (or other active Ethernet infrastructure), a switching center (in one example, a switching center should have multiple routing to different locations), a data center (in one example, a data center should have multiple routing to different locations), an optical network terminal, a whitebox network element, an edge routing facility (including equipment), a core routing facility (including equipment), a hybrid fiber-coaxial terminal, a line amplifier, or other network elements.

Whatever the nature of the communications network, in one example, the network may be housed in a structure whose hardening has been augmented using nanoparticle paints, Faraday fabrics, or other materials that can be used to increase the hardening of a structure. In one example, the augmentation may result in a total hardening of approximately forty to fifty dB for the structure (where the hardening of the structure, pre-augmentation, may have been approximately twenty to thirty dB).

In the event of a network-wide failure, the network element (as well as others of the plurality of network elements) may lose power and/or connectivity to the communications network. If power has been lost, then the network element may need to power up and reboot. Once rebooted, network element will need to reestablish its connection to the communications network. However, race conditions may result if all network elements that have lost connectivity attempt to reestablish their connections simultaneously. As such, the recovery data for each network element will define a respective interval of time. For the network element, this respective interval of time defines an amount of time (e.g., in seconds, minutes, or the like) after the network-wide failure or reboot of the network element to wait before attempting a reconnection to the communications network. The duration of the respective interval of time may be different for the network element than it is for other network elements of the plurality of network elements (e.g., shorter or longer), so that the plurality of network elements come back online in a staggered or gradual manner.

The recovery data for the network element will also define a respective maximum number of times to attempt the reconnection. For instance, an attempt to reconnect to the communications network may fail for any one or more of a number of reasons, including the possibility that other network elements may not yet be reconnected. Thus, the recovery data may allow for the network element to reattempt reconnecting to the communications network in the event that a previous attempt is unsuccessful. However, the number of reattempts may be capped at a maximum number to avoid overwhelming the network or inadvertent masking of other problems with the network element. Like the duration of the interval of time, the maximum number of times to attempt the reconnection may be different for the network element than the duration for other network elements of the plurality of network elements.

In a further example, the recovery data may include additional parameters related to the reboot and network reconnection of the network element. For instance, the recovery data may further include data related to alternate routing or dependencies for the network element. As discussed above, some network elements, such as a mobile telephone switching office, a mobility packet core location, a switching center, or a data center may have primary and secondary routing to multiple alternate network elements in different locations. Thus, the recovery data may identify, for such network elements, the alternate network elements. As also discussed above, some network elements may be unable to reconnect to the communications network before other network elements first reconnect. In this case, the recovery data may identify, for a given network element, any network elements that must reconnect before the given network element can reconnect and/or any network elements that cannot reconnect until the given network element reconnects.

In step 306, the processing system may receive the recovery data from the remote device. For instance, the recovery data may be encoded in an electronic signal received from the remote device, and the processing system may be configured to decode or extract the recovery data from the electronic signal.

In step 308, the processing system may store the recovery data in a memory of the network element. Storing the recovery data locally in the memory of the network element ensures that the network element has access to the recovery data in the event of a network-wide failure (e.g., in which case the network element may not be able to contact the remote device for the recovery data). In one example, storing the recovery data may include deleting existing recovery data that is currently stored in the memory of the network element, so that only the recovery data that is received in step 306 (i.e., the most recent recovery data) remains in the memory of the network element.

In step 310, the processing system may detect a failure (broadly a “first” failure only for labeling purposes as used in the claims) of the communications network. In one example, the processing system may detect the failure by detecting that the processing system has lost connectivity to the communications network. In another example, the processing system may detect the failure by detecting an unscheduled reboot or restart of the processing system in combination with a loss of connectivity to the communications network.

In step 312, the processing system may activate a timer of the network element, where the timer is configured to count down an amount of time that is equal in duration to a duration of the interval of time. Thus, the timer may be activated in response to detecting the failure of the communications network. In one example, the timer is a hardware timer that is integrated with the processing system. Activation of the timer may cause the timer to begin counting down until the duration of the interval of time has elapsed, causing an expiration of the timer.

In step 314, the processing system may, in response to the timer expiring, attempt the reconnection to the communications network. In one example, the processing system will not attempt the reconnection to the communications network until the full duration of the interval of time has elapsed. As discussed above, this ensures that, in the event that the failure detected in step 310 was network-wide, all network elements of the plurality of network elements do not attempt reconnection to the communications network simultaneously and cause race conditions or other issues that may delay full restoration of the communications network.

The attempted reconnection may or may not succeed. For instance, if the processing system is unable to reconnect to the communications network before another network element has reconnected to the communications network, and that another network element has not yet reconnected, then at least the first attempted reconnection in step 314 may fail. However, as discussed above and in further detail below, the processing system may, in some examples, reattempt the reconnection in the event that the first attempt at reconnection fails.

In step 316, the processing system may determine whether the reconnection was successful. In one example, the processing system may determine whether the reconnection was successful by determining whether the processing system is able to detect signals (e.g., radio signals) emitted by other network elements of the plurality of network elements. For instance, if the processing system is able to detect signals emitted by other network elements of the plurality of network elements, then this may indicate that the processing system has successfully reconnected to the communications network. If, however, the processing system is unable to detect signals emitted by other network elements of the plurality of network elements, then this may indicate that the processing system has not yet reconnected to the communications network.

If the processing system concludes in step 316 that the reconnection was successful, then the method 300 may return to step 304, and the processing system may continue as described above, querying the remote device for updated recovery data for the network element. For instance, as discussed above, the recovery data for the network element may change over time as changes are made to the communications network, including the addition, removal, and/or movement of other network elements. If, however, the processing system concludes in step 316 that the reconnection was unsuccessful, then the method 300 may proceed to step 318.

In optional step 318 (illustrated in phantom), the processing system may determine whether the maximum number of times to attempt the reconnection has been reached. Step 318 may be optional, because the initial attempt at reconnection in step 312 may have been successful (in which case, step 318 may be unnecessary). As discussed above, the recovery data received in step 306 includes a maximum number of times to attempt the reconnection following the failure of the communications network. This allows for the possibility that some network elements may not be able to reconnect to the communications network on their first attempts, due to dependencies on other network elements may not yet be reconnected and/or other issues.

In one example, the maximum number of times to attempt the reconnection may be different for different network elements. In one example, the maximum number of times to attempt the reconnection may be zero, i.e., the processing system is permitted to make only a single attempt at reconnection to the communications network. However, in other examples, the maximum number of times to attempt the reconnection may be a non-zero number, allowing the processing system to make at least one further attempt at reconnection to the communications network in the event that a first attempt fails. However, in one example, the processing system may not be permitted to make unlimited attempts at reconnection to the communications network, to avoid overwhelming the network or inadvertently masking of other problems with the network element.

If the processing system concludes in step 318 that the maximum number of times to attempt the reconnection has not been reached, then the method 300 may return to step 312 and may continue as described above to re-activate the timer for a subsequent attempt to reconnect to the communications network.

Thus, the processing system may repeat its attempt at reconnection to the communications network. However, in one example, any subsequent attempts at reconnection after the first attempt must also abide by the interval of time that is specified in the recovery data. Thus, each time an attempt at reconnection to the communications network fails (and assuming that the maximum number of times to attempt the reconnection has not been reached), the timer may be reset, so that the processing system must wait for a duration of time that is equal to the duration of the interval of time before making a subsequent attempt at reconnection.

If, however, the processing system concludes in step 318 that the maximum number of times to attempt the reconnection has been reached, then the method 300 may end in step 320. For instance, if the processing system is unable to successfully reconnect to the communications network after making the maximum number of permitted attempts at reconnection, then this may indicate an issue with the processing system or the communications network that requires further attention.

Although not expressly specified above, one or more steps of the method 200 or the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

The methods 200 and 300 embody a recovery routine that, in combination with augmented hardening of the structures used to house the network elements of a communications network, provide the communications network with a level of resiliency to environmental threats that is sufficient to prevent prolonged disruption, but at a fraction of the cost of measures employed for military applications.

FIG. 4 depicts a high-level block diagram of a computing device specifically programmed to perform the functions described herein. For example, any one or more components or devices illustrated in FIG. 1 or described in connection with the method 200 or the method 300 may be implemented as the system 400. For instance, an application server (such as might be used to perform the method 200) or a network element (such as might be used to perform the method 300) could be implemented as illustrated in FIG. 4.

As depicted in FIG. 4, the system 400 comprises a hardware processor element 402, a memory 404, a module 405 for improving communications network resiliency to environmental threats, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for improving communications network resiliency to environmental threats may include circuitry and/or logic for activating timers and tracking a number of attempts at reconnection to a communications network. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for improving communications network resiliency to environmental threats (e.g., a software program comprising computer-executable instructions) can be loaded into memory 404 and executed by hardware processor element 402 to implement the steps, functions or operations as discussed above in connection with the example method 200 or example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for improving communications network resiliency to environmental threats (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
querying, by a processing system including at least one processor, a remote device for recovery data for a network element of a communications network, where the recovery data includes at least: an interval of time to wait before attempting a reconnection to the communications network following a failure of the communications network and a maximum number of times to attempt the reconnection following the failure;
receiving, by the processing system, the recovery data from the remote device;
storing, by the processing system, the recovery data in a memory of the network element;
detecting, by the processing system, a first failure of the communications network;
activating, by the processing system in response to the detecting, a timer of the network element, where the timer is configured to count down an amount of time that is equal in duration to a duration of the interval of time; and
attempting, by the processing system in response to the timer expiring, the reconnection to the communications network.

2. The method of claim 1, wherein the processing system is part of the network element.

3. The method of claim 2, wherein the communications network comprises a communications telecommunications network, and the network element comprises one of: a radio unit on a cellular base station, a baseband unit at a cell site, a smart integrated access device at a cell site, a global positioning system at a cell site, a network timing alarm at a cell site, a door alarm at a cell site, a heating, ventilation, and air conditioning alarm at a cell site, network terminating equipment for ethernet transport infrastructure at a cell site, an optical fiber regeneration site, an optical add/drop infrastructure, an optical monitoring infrastructure, an optical cable locate infrastructure, an ethernet network infrastructure at a central office, a mobile telephone switching office, a mobility packet core location, a switching center, a data center, a central office location, a gigabit passive optical network, an optical network terminal, a whitebox network element, an edge routing facility, or a core routing facility.

4. The method of claim 2, wherein the communications network comprises a cable television operator network, and the network element comprises one of: an optical fiber regeneration site, an optical add/drop infrastructure, an optical monitoring infrastructure, an optical cable locate infrastructure, an ethernet network infrastructure, a gigabit passive optical network, a switching center, a data center, an optical network terminal, a whitebox network element, an edge routing facility, a core routing facility, a hybrid fiber-coaxial terminal, or a line amplifier.

5. The method of claim 1, wherein the network element is housed in a structure whose hardening has been augmented.

6. The method of claim 5, wherein the hardening has been augmented using at least one of: a nanoparticle paints or a faraday fabric.

7. The method of claim 1, wherein the recovery data further comprises data related to at least one of: alternate routing for the network element or a dependency for the network element.

8. The method of claim 1, wherein the storing the recovery data comprises overwriting existing recovery data that is currently stored in the memory of the network element.

9. The method of claim 1, wherein the timer is a hardware timer that is integrated with the processing system.

10. The method of claim 1, further comprising:
determining, by the processing system, that the reconnection was unsuccessful; and
repeating, by the processing system in response to determining that the maximum number of times to attempt the reconnection has not been reached, the activating and the attempting.

11. The method of claim 10, further comprising:
repeating, by the processing system, the determining that the reconnection was unsuccessful and the repeating the activating and the attempting up to a number of times that is equal to the maximum number of times to attempt the reconnection.

12. The method of claim 1, further comprising:
periodically repeating the querying, the receiving, and the storing while the network element is connected to the communications network.

13. The method of claim 1, wherein the interval of time to wait before attempting the connection to the communications network for the network element has a different duration than an interval of time to wait before attempting a connection to the communications network for a different network element of the communications network.

14. The method of claim 1, wherein the maximum number of times to attempt the reconnection for the network element has a different duration than a maximum number of times to attempt a reconnection for a different network element of the communications network.

15. The method of claim 1, wherein the recovery data is defined by a technician.

16. The method of claim 1, wherein the remote device comprises an application server, and the application server is communicatively coupled to a database that stores the recovery data for a plurality of network elements of the communications network including the network element.

17. The method of claim 16, where the database is updated when a change is made to a topology of the communications network.

18. The method of claim 16, wherein multiple instances of the application server and the database are distributed throughout the communications network.

19. A non-transitory computer-readable medium storing instructions which, when executed by a processing system including at least one processor, cause the processing system to perform operations, the operations comprising:
querying a remote device for recovery data for a network element of a communications network, where the recovery data includes at least: an interval of time to wait before attempting a reconnection to the communications network following a failure of the communications network and a maximum number of times to attempt the reconnection following the failure;
receiving the recovery data from the remote device;
storing the recovery data in a memory of the network element;
detecting a first failure of the communications network;
activating, in response to the detecting, a timer of the network element, where the timer is configured to count down an amount of time that is equal in duration to a duration of the interval of time; and
attempting, in response to the timer expiring, the reconnection to the communications network.

20. A device comprising:
a processing system including at least one processor; and
a computer-readable medium storing instructions which, when executed by the processing system, cause the processing system to perform operations, the operations comprising:
querying a remote device for recovery data for a network element of a communications network, where the recovery data includes at least: an interval of time to wait before attempting a reconnection to the communications network following a failure of the communications network and a maximum number of times to attempt the reconnection following the failure;
receiving the recovery data from the remote device;
storing the recovery data in a memory of the network element;
detecting a first failure of the communications network;
activating, in response to the detecting, a timer of the network element, where the timer is configured to count down an amount of time that is equal in duration to a duration of the interval of time; and
attempting, in response to the timer expiring, the reconnection to the communications network.
